(19) United States
(12) Patent Application Publication
(10) Pub. No.: US 2018/0046474 A1
(43) Pub. Date: Feb. 15, 2018

(54) METHOD FOR EXECUTING CHILD KERNELS INVOKED ON DEVICE SIDE UTILIZING DYNAMIC KERNEL CONSOLIDATION AND RELATED NON-TRANSITORY COMPUTER READABLE MEDIUM

(71) Applicants: National Taiwan University, Taipei City (TW); MEDIATEK INC., Hsin-Chu (TW)

(72) Inventors: Po-Han Wang, Taipei City (TW); Chia-Lin Yang, Taipei City (TW)

(21) Appl. No.: 15/677,039

(22) Filed: Aug. 15, 2017

Related U.S. Application Data
(60) Provisional application No. 62/374,927, filed on Aug. 15, 2016.

(51) Int. Cl. G06F 9/445

(52) U.S. Cl. CPC G06F 9/44521

(57) ABSTRACT

A method for executing a plurality of child kernels invoked on a device side is provided. The child kernels are invoked in response to a parent kernel launched from a host side. The method includes the following steps: linking the child kernels to enqueue a plurality of threads of the child kernels; regrouping the threads of the child kernels to generate a plurality of thread blocks each having N threads, wherein N is a positive integer greater than one; merging the thread blocks to generate a consolidated kernel; and executing the consolidated kernel on the device side to execute a kernel function of the child kernels.

### CROSS REFERENCE TO RELATED APPLICATIONS

This application claims the benefit of U.S. provisional application No. 62/374,927, filed on Aug. 15, 2016, the contents of which are incorporated herein by reference.

### BACKGROUND OF THE INVENTION

### 1. Field of the Invention

The disclosed embodiments of the present invention relate to device-side launched kernels, and more particularly, to a method for regrouping threads of device-side launched kernels to dynamically merge the device-side launched kernels, and a related non-transitory computer readable medium.

### 2. Description of the Prior Art

As irregular general-purpose computing on graphics processing unit (GPGPU) applications often operate on unstructured data sets such as trees, graphs or sparse matrices, device-side kernel launching functionality is introduced to implement dynamic parallelism. However, since it is difficult for a programmer to optimize configurations on the device side, device-side launched kernels tend to have few threads per kernel to avoid performance degradation, which results in decreased GPU utilization. In addition, as the programmer cannot control the number of threads of a device-side launched kernel, and GPU has a limit on the maximum number of concurrent kernels, it is difficult to maximize the GPU utilization during execution of the device-side launched kernel.

Thus, there is a need for a novel device-side launched kernel execution mechanism to improve GPU execution efficiency.

### SUMMARY OF THE INVENTION

In accordance with exemplary embodiments of the present invention, a method for regrouping threads of device-side launched kernels to dynamically merge the device-side launched kernels, and a related non-transitory computer readable medium are proposed to solve the above-mentioned problems.

According to an embodiment of the present invention, an exemplary method for executing a plurality of child kernels invoked on a device side is disclosed. The child kernels are invoked in response to a parent kernel launched from a host side. The exemplary method comprises the following steps: linking the child kernels to enqueue a plurality of threads of the child kernels; regrouping the threads of the child kernels to generate a plurality of thread blocks each having N threads, wherein N is a positive integer greater than one; merging the thread blocks to generate a consolidated kernel; and executing the consolidated kernel on the device side to execute a kernel function of the child kernels.

According to an embodiment of the present invention, an exemplary non-transitory computer readable medium having a program code stored therein is disclosed. When executed by a processor, the program code causes the processor to execute the following steps: linking a plurality of child kernels invoked on a device side to enqueue a plurality of threads of the child kernels, wherein the child kernels are invoked in response to a parent kernel launched from a host side; regrouping the threads of the child kernels to generate a plurality of thread blocks each having N threads, wherein N is a positive integer greater than one; merging the thread blocks to generate a consolidated kernel; and executing the consolidated kernel on the device side to execute a kernel function of the child kernels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary dynamical kernel consolidation framework according to an embodiment of the present invention.

FIG. 2 is a flow chart of an exemplary method for executing a plurality of child kernels invoked on a device side according to an embodiment of the present invention.

FIG. 3 is a diagram illustrating an exemplary computer system according to an embodiment of the present invention.

FIG. 4 is a diagram illustrating an exemplary simplified child kernel function of BFS according to an embodiment of the present invention.

FIG. 5 is a diagram illustrating exemplary dynamic consolidation of a plurality of child kernels employing the simplified child kernel function shown in FIG. 4 according to an embodiment of the present invention.

FIG. 6 is a diagram illustrating an exemplary task distributor used for dynamically merging the child kernels shown in FIG. 5 according to an embodiment of the present invention.

FIG. 7 is a diagram illustrating an exemplary off-chip memory for storing kernel parameters associated with dynamic kernel consolidation shown in FIG. 6.

FIG. 8 is a block diagram illustrating an exemplary computer system according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

The proposed dynamic kernel consolidation mechanism may refer to a predetermined block size and/or a predetermined grid size to dynamically regroup threads of a plurality of child kernels launched on a device side, and merge/reform resulting thread blocks to at least one consolidated kernel. In contrast to the conventional method which executes the launched child kernels directly, the proposed dynamic kernel consolidation mechanism execute the consolidated kernel having the predetermined block size and/or the predetermined grid size to thereby greatly increase processor utilization (e.g. GPU utilization) on the device side. Further description is provided below.

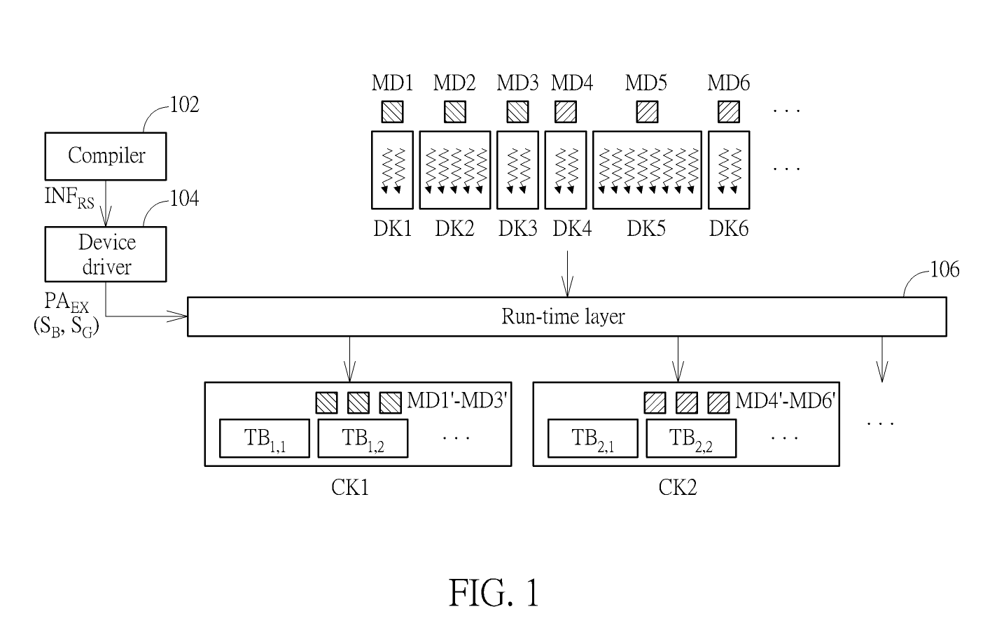

FIG. 1 is a diagram illustrating an exemplary dynamical kernel consolidation (DKC) framework according to an embodiment of the present invention. In this embodiment, after a plurality of child kernels (including a plurality of child kernels DK1-DK6) are invoked on a device side (e.g. a GPU) in response to a parent kernel launched from a host side (e.g. a central processing unit (CPU)), a compiler 102 may provide resource usage information INF_{RS} to a device driver 104, wherein the child kernels DK1-DK6 may include different numbers of threads, and the resource usage information INF_{RS} may include, but is not limited, the number of registers used by each thread, and the amount of shared memory allocated for each thread block. The device driver 104 may refer to the resource usage information INF_{RS} to determine execution parameters PA_{EX} such as a block size S_{B} (i.e. S_{B} threads per thread block) and a grid size S_{G} (i.e. S_{G} thread blocks per kernel).

A run-time layer 106 may perform kernel consolidation/splitting and thread block regrouping on the child kernels according to the execution parameters PA_{EX} to thereby generate a plurality of consolidated kernels (including a plurality of consolidated kernels CK1 and CK2). By way of example but not limitation, the run-time layer 106 may refer to the block size S_{D} and the grid size S_{G} to regroup a plurality of threads of the child kernels, thereby merging the child kernels DK1-DK3 into the consolidated kernel CK1 and merging the child kernels DK4-DK6 into the consolidated kernel CK2. Each thread block in the consolidated kernels CK1 and CK2 (e.g. the thread block TB_{1,1}/TB_{1,2}/TB_{2,1}/TB_{2,2}) may have S_{B} threads, and each of the consolidated kernels CK1 and CK2 may have S_{G} thread blocks. Please note that, after the child kernels are regrouped/merged into the consolidated kernels, a thread block in one of the consolidated kernels may include threads coming from different child kernels, and/or a thread clock in one of the consolidated kernels may include threads coming from different thread blocks of a child kernel.

In some embodiments, when performing kernel consolidation/splitting and thread block regrouping, the run-time layer 106 may link the child kernels together (e.g. building a linked list) to enqueue a plurality of threads of the child kernels. Hence, even if different threads in a thread block of a consolidated kernel require different kernel parameters, the device side may directly execute this consolidated kernel to execute a kernel function of the child kernels, wherein the child kernels may perform the kernel function using different kernel parameters. In other words, after the child kernels are dynamically consolidated, the proposed DKC framework may refer to a linking relationship between the child kernels to access kernel parameters required by the kernel function.

Byway of example but not limitation, the child kernels DK1-DK6 may correspond to metadata MD1-MD6 each including corresponding kernel parameters, wherein the compiler 102 may record relative positions of data pointers of kernel parameters. When executing a thread of a consolidated kernel, the device side may refer to the recorded relative positions to offset a position of a data pointer of corresponding metadata (e.g. one of metadata MD1′-MD6′) in order to access data corresponding to the thread.

Additionally, the number of thread blocks and/or the number of threads in each child kernel shown in FIG. 1 is for illustrative purposes only, and is not meant to be a limitation of the present invention. For example, the child kernel DK1 may have more than two threads. Further, the number of thread blocks in each consolidated kernel shown in FIG. 1 is for illustrative purposes only. In other words, FIG. 1 is not intended to limit the threads of the child kernels DK1-DK3 to be regrouped into the thread blocks TB_{1,1} and TB_{1,2}.

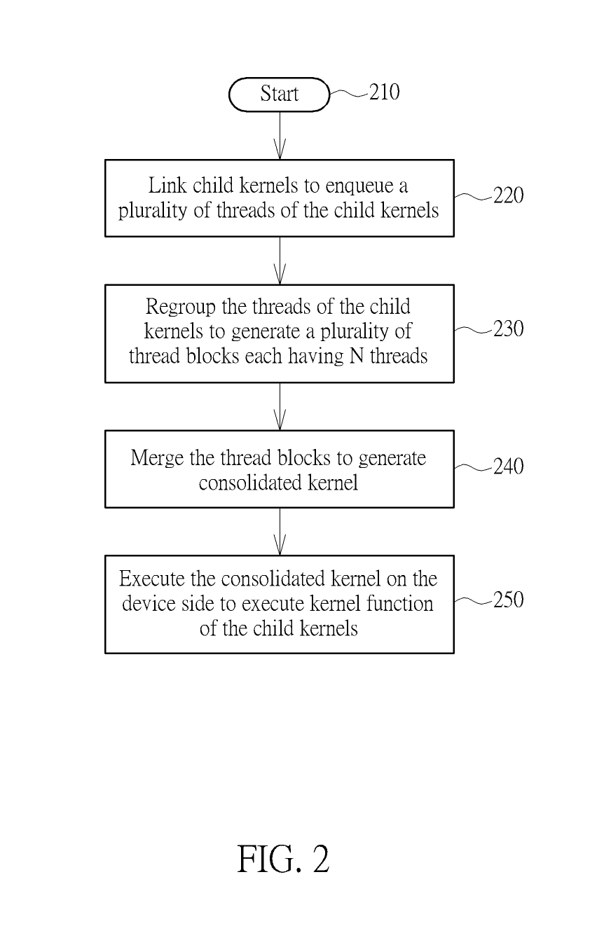

The DKC mechanism shown in FIG. 1 may be summarized in FIG. 2. FIG. 2 is a flow chart of an exemplary method for executing a plurality of child kernels invoked on a device side according to an embodiment of the present invention. Provided that the result is substantially the same, steps are not required to be executed in the exact order shown in FIG. 2. For example, steps can be added without departing from the scope of the present invention. In addition, the exemplary method shown in FIG. 2 is described with reference to the DKC framework shown in FIG. 1 for illustrative purposes. This is not intended as a limitation of the present invention. The exemplary method shown in FIG. 2 may be summarized below.

Step 210: Start. For example, the child kernels including the child kernels DK1 and DK2 are invoked on a device side (e.g. a GPU) in response to a parent kernel launched from a host side (e.g. a CPU).

Step 220: Link the child kernels to enqueue a plurality of threads of the child kernels.

Step 230: Regroup the threads of the child kernels to generate a plurality of thread blocks each having N threads (i.e. a predetermined block size), wherein N is a positive integer greater than one.

Step 240: Merge the thread blocks to generate a consolidated kernel such as the consolidated kernel CK1/CK2.

Step 250: Execute the consolidated kernel on the device side to execute a kernel function of the child kernels. For example, in a case where the device side includes a plurality of processors to perform parallel processing, the processors may process thread blocks regrouped into the consolidated kernel CK1 (e.g. the thread block TB_{1,1}/TB_{1,2}), rather than thread blocks grouped into a child kernel (e.g. the child kernel DK1), respectively.

In step 230, the device drive 104 may determine a block size (e.g. the block size S_{B} determined according to the resource usage information INF_{RS}) so as to refer to the determined block size to regroup the threads of the child kernels. For example, the device drive 104 may calculate a plurality of processor occupancies of a processor (e.g. a streaming multiprocessor in a GPU) on the device side respectively corresponding to a plurality of candidate block sizes, wherein each processor occupancy is a ratio of a number of active warps on the processor to a maximum number of concurrent warps supported by the processor, and each candidate block size is an integer multiple of a number of threads per warp. Next, the device drive 104 may select a candidate block size corresponding to a maximum of the processor occupancies as a block size of each of the thread blocks, wherein the candidate block size is N threads per thread block (e.g. the block size S_{B}).

In step 240, in a case where the device side includes P processors, and Q thread blocks are assigned to each processor (each of P and Q is a positive integer greater than one), the device drive 104 may divide a product of P and Q by a maximum number of concurrent kernels supported by the device side to determine a predetermined number of thread blocks, thereby referring to at least the predetermined number of thread blocks to merge the thread blocks to generate the consolidated kernel. For example, the device driver 104 may check if a number of thread blocks in the consolidated kernel CK1 reaches the predetermined number of thread blocks. When the number of thread blocks in the consolidated kernel CK1 reaches the predetermined number of thread blocks, the run-time layer 106 may dispatch the consolidated kernel CK1 to execute an associated kernel function. In another example, the device driver 104 may check if a number of threads in the thread blocks reaches the determined predetermined number of thread blocks multiplied by N. When the number of threads in the thread blocks reaches the determined predetermined number of thread blocks multiplied by N, the run-time layer 106 may dispatch the generated consolidated kernel CK1 execute an associated kernel function.

Additionally, in some embodiments, after the threads are regrouped and merged/consolidated, one of the thread blocks of the consolidated kernel CK1/CK2 may include at least one thread of a child kernel (e.g. the child kernel DK1) and at least one thread of another child kernel (e.g. one of the child kernels DK2-DK6). In other embodiments, after the threads are regrouped and merged/consolidated, one of the thread blocks of the consolidated kernel CK1 may include at least one thread of one thread block of a child kernel (e.g. the child kernel DK1) and at least one thread of another thread block of the child kernel.

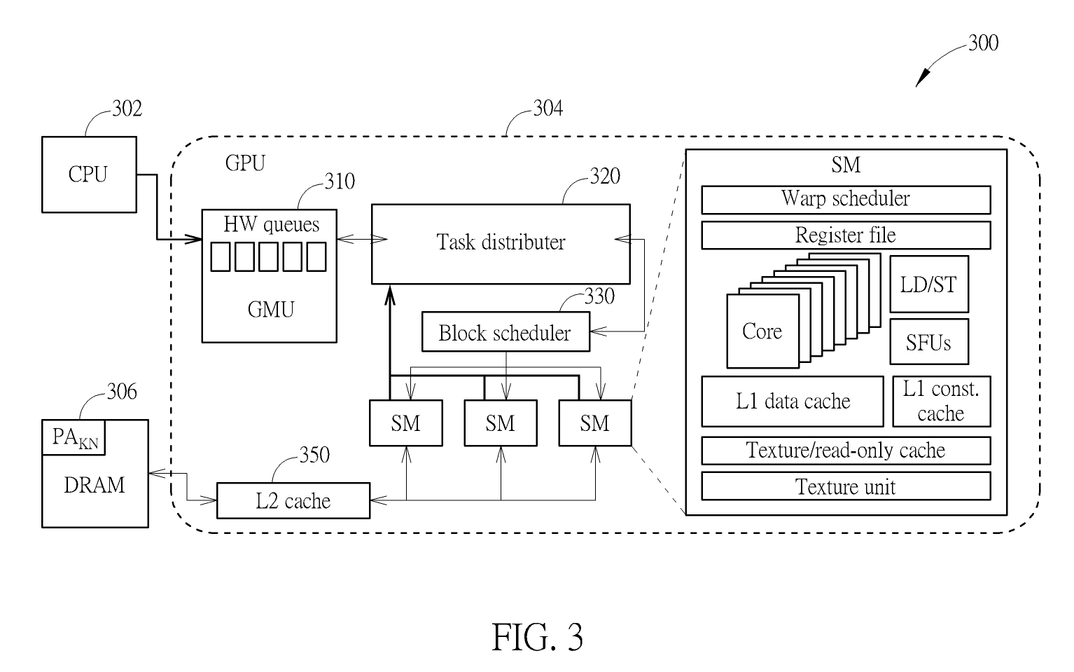

To facilitate an understanding of the present invention, an exemplary implementation is given in the following for further description of the proposed dynamic kernel consolidation. However, this is for illustrative purposes only. As long as child kernels may be dynamically regrouped and merged/consolidated, other device sides employing the proposed dynamic kernel consolidation mechanism shown in FIG. 1/FIG. 2 are feasible. Please refer to FIG. 3, which is a diagram illustrating an exemplary computer system 300 according to an embodiment of the present invention. In this embodiment, the computer system 300 may include, but is not limited to, a host side (implemented by a CPU 302 in this embodiment), a device side (implemented by a GPU 304 in this embodiment), and an off-chip memory (implemented by a dynamic random access memory (DRAM) 306 in this embodiment), wherein the device side may perform dynamic kernel consolidation. The GPU 304 may invoke a plurality of child kernels in response to a parent kernel launched from the CPU 302, and access kernel parameters PA_{KN} stored in the DRAM 306 to execute kernel functions. The GPU 304 may include, but is not limited to, a grid management unit (GMU) 310, a task distributor 320, a block scheduler 330, a plurality of processors or compute units (CUs) (implemented by a plurality of streaming multiprocessors, each being labeled SM, in this embodiment) and a level 2 (L2) cache 350.

In this embodiment, each streaming multiprocessor may include, but is not limited to, a plurality cores (or arithmetic logic units (ALUs)), a plurality of load/store units (labeled LD/ST), a plurality of special-function units (SFUs), register files, a Level 1 (L1) data cache (used as a shared scratchpad memory), a L1 constant cache (labeled L1 const. cache), a texture/read-only cache, and a texture unit. As a person skilled in the art should understand operations of each streaming multiprocessor utilizing aforementioned elements, further description associated with aforementioned elements in a streaming multiprocessor is omitted here for brevity.

The CPU 302 may dispatch configurations (or metadata) of a parent kernel to GMU 310 to launch the parent kernel. For example, the CPU 302 may launch GPU kernels by dispatching kernel launching commands, wherein a kernel parameter address is part of a kernel launching command along with other kernel information such as dimension configuration and a program counter address. The kernel launching commands are passed to the GPU 304 through software stream queues (e.g. CUDA stream), which are mapped to hardware work queues (labeled HW queues) in the GMU 310 that create hardware-managed connections between the CPU 302 and the GPU 304. Next, the GMU 310 may send the parent kernel to the task distributor 320, which may keep the status of running kernels (e.g. metadata of the running kernels). It should be noted that the task distributor 320 may further receive at least one child kernel invoked by each streaming multiprocessor SM, and perform dynamic kernel consolidation to generate consolidated kernel(s). For illustrative purposes, dynamic kernel consolidation operations of the task distributor 320 may be described below with a child kernel function of breadth-first search (BFS). However, this is not meant to be a limitation of the present invention.

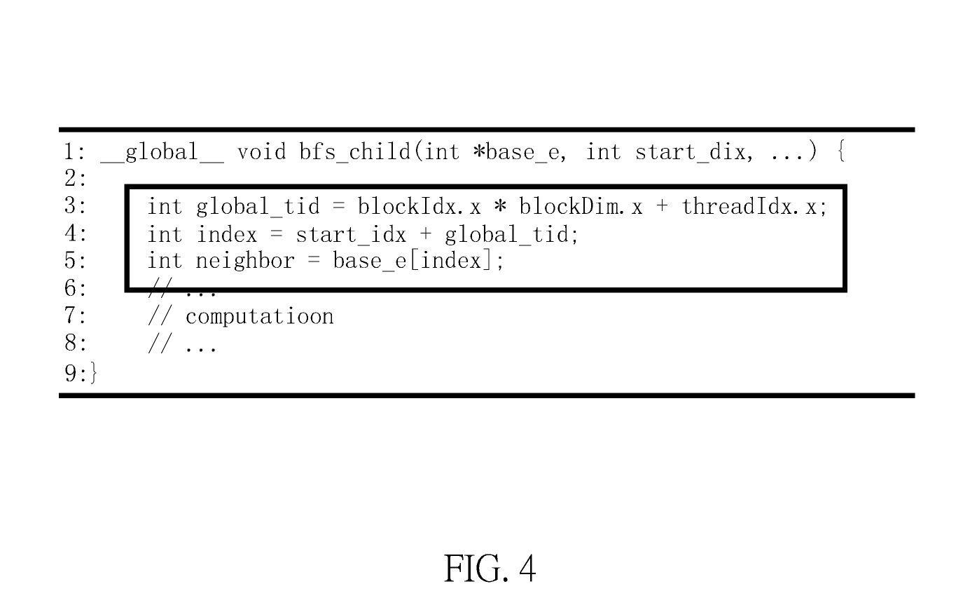

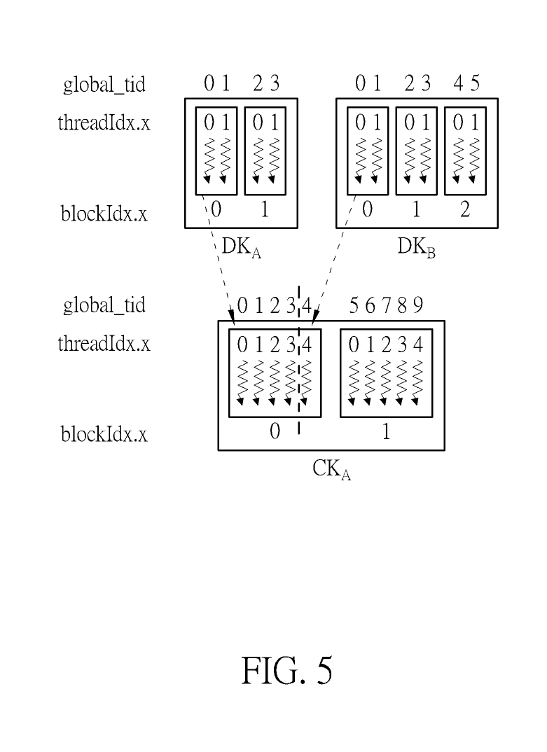

First, please refer to FIG. 4 and FIG. 5. FIG. 4 is a diagram illustrating an exemplary simplified child kernel function of BFS according to an embodiment of the present invention, and FIG. 5 is a diagram illustrating exemplary dynamic consolidation of a plurality of child kernels employing the simplified child kernel function shown in FIG. 4 according to an embodiment of the present invention. In this embodiment, a child kernel may be invoked by a node of a graph (mapped onto a thread of a parent kernel) to process all its neighbors. After the child kernel starts, each thread may calculate its data address based on the address calculation code specified by the program (indicated by the rectangle shown in FIG. 4), wherein the thread may be identified with its block ID blockIdx.x and local thread ID threadIdx.x. In addition, different child kernels may access different parts of the data array by assigning different data pointers base_e or different starting indices start_idx.

Please note that the global thread ID global_tid of each thread is determined from the equality: global_tid=blockIdx.x×blockDim.x+threadIdx.x, wherein the block dimension ID blockDim.x represents a number of threads in a corresponding thread block. In a case where child kernels DK_{A} and DK_{B} are dynamically consolidated to generate a consolidated kernel CK_{A}, the global thread ID global_tid of each thread in the child kernel DK_{B} linked after the child kernel DK_{A} is increased by 4, which is the amount of threads in the child kernel DK_{A}. Hence, the data pointer base_e may have a position offset.

When the device side executes a thread of the consolidated kernel (e.g. coming from the child kernel DK_{B}), the proposed DKC mechanism may offset a position of a data pointer corresponding to the child kernel (e.g. the data pointer base_e) according to a total number of threads enqueued prior to the child kernel, in order to compensate a position offset introduced in the data pointer. Next, the proposed DKC mechanism may refer to the offset data pointer to access data of a kernel function to the child kernel. For example, an offset data pointer base_e₂′ corresponding to the child kernel DK_{B} may be expressed as follows:

base_e₂′=base_e₂−|DK_{B}|×sizeof(*base_e),

where base_e₂ represents a data pointer of the child kernel DK_{B} before compensated, |DK_{B}| represents the number of threads in the child kernel DK_{B}, and sizeof (*base_e) represents the size of the data pointer. Hence, even if the block ID blockIdx.x and the local thread ID threadIdx.x of the child kernel DK_{B} are changed after merged into the consolidated kernel CK_{A}, the device side may successfully access required data of the data array.

Please note that, in this embodiment, as a thread block of the consolidated kernel CK_{A} (a thread block having a block ID blockIdx.x of 0) may include threads coming from different child kernels, a storage element may be disposed in correspondence with each thread to store corresponding kernel parameters. For example, in a case where the consolidated kernel CK_{A} includes M threads (M is a positive integer greater than one), the device side may have kernel parameters corresponding to the M threads of the consolidated kernel CK_{A} stored into M storage elements respectively, wherein the M storage elements may be M existing registers in the streaming multiprocessors shown in FIG. 3, or M extra registers disposed in the streaming multiprocessors shown in FIG. 3.

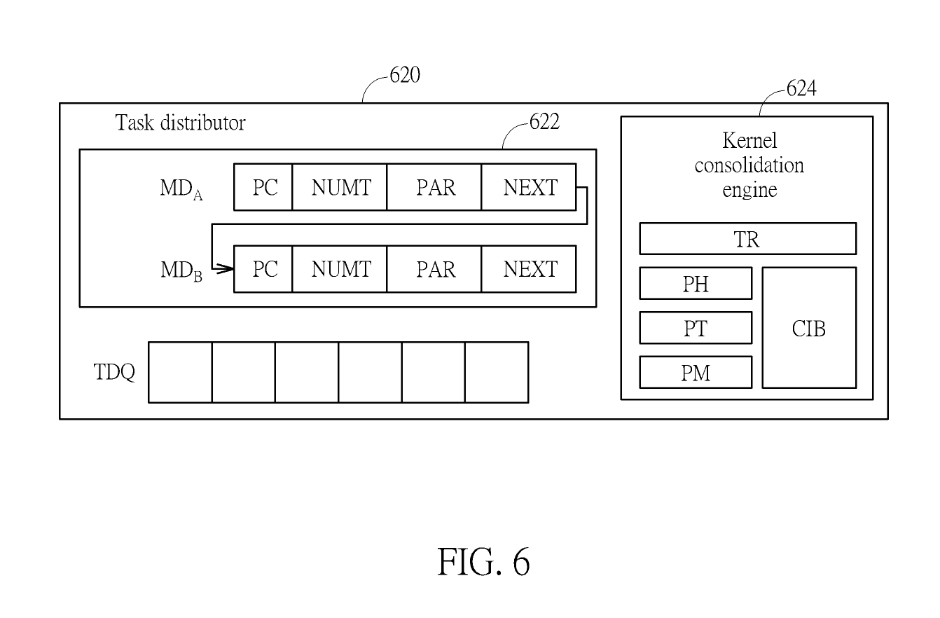

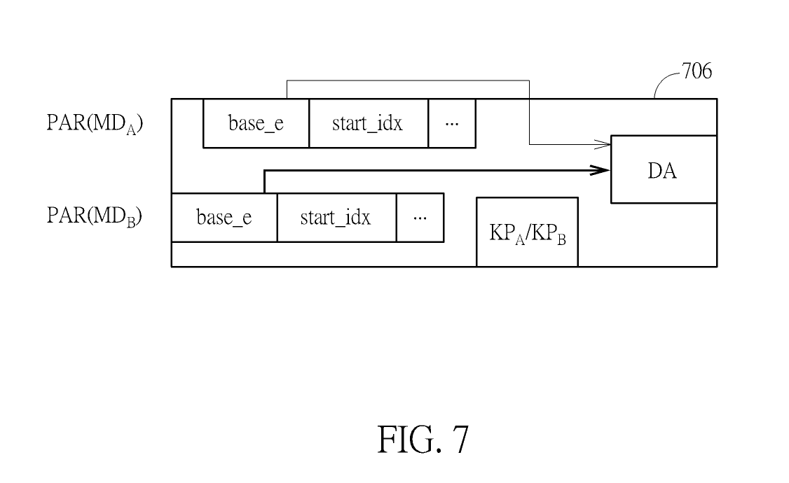

Please refer to FIG. 6 and FIG. 7 in conjunction with FIG. 5. FIG. 6 is a diagram illustrating an exemplary task distributor used for dynamically merging the child kernels DK_{A} and DK_{B} shown in FIG. 5 according to an embodiment of the present invention, and FIG. 7 is a diagram illustrating an exemplary off-chip memory for storing kernel parameters associated with dynamic kernel consolidation shown in FIG. 6. Please note that the task distributor 320 and the DRAM 306 shown in FIG. 3 may be implemented by the task distributor 620 shown in FIG. 6 and the off-chip memory (implemented by a DRAM 706 in this embodiment) shown in FIG. 7 respectively. The task distributor 620 may include, but is not limited, a metadata buffer (MDB) 622, a kernel consolidation engine (KCE) 624 and a task distributor queue TDQ, wherein the MDB 622 may be a built-in buffer of the task distributor 620. When the child kernel DK_{A} is invoked, the corresponding kernel parameter PAR(MD_{A}) and program binary KP_{A} may be stored in the DRAM 706 (e.g. a global memory; when the child kernel DK_{B} is invoked, the corresponding kernel parameter PAR(MD_{B}) and program binary KP_{B} may be stored in the DRAM 706. Additionally, data required for child kernels DK_{A} and DK_{B} may be stored in a data region DA of the DRAM 706.

The MDB 622 may store respective configurations of the child kernels DK_{A} and DK_{B} (the metadata MD_{A} and MD_{B}), wherein each of the metadata MD_{A} and MD_{B} may include a program pointer PC, a total number of threads NUMT, a kernel parameter pointer PAR, a next pointer NEXT and a number of dispatched threads (not shown in FIG. 6). For example, regarding the metadata MD_{A} of the child kernel DK_{A}, the program pointer PC may point to the binary of the child kernel DK_{A}, the total number of threads NUMT is the number of threads in the child kernel DK_{A}, the kernel parameter pointer PAR may point to an address of the kernel parameter PAR(MD_{A}), and the next pointer NEXT may point to metadata of a child kernel which is to be linked to the metadata MD_{A}.

The task distributor queue TDQ may store metadata of kernels that can be selected by a block scheduler (e.g. the block scheduler 330 shown in FIG. 3) for dispatching. The KCE 624 may merge multiple child kernels into consolidated kernel(s), and refer to a block size and a grid size determined by a device driver (e.g. the device driver 104 shown in FIG. 1) to set the number of threads per block and per kernel. In some embodiments, the KCE 624 may utilize registers to build a linked list between child kernels. Specifically, the KCE 624 may include, but is not limited to, a head pointer PH (a register), a tail pointer PT (a register), a temporary pointer PM (a register) and a thread number register TR. The head pointer PH may point to the first metadata of a current consolidated kernel, the tail pointer PT may point to the last metadata of the current consolidated kernel, the temporary pointer PM may point to a newly invoked child kernel (i.e. a next child kernel to be merged), and the thread number register TR may record the total number of threads in the current consolidated kernel.

For example, in a case where the child kernel DK_{A} has been merged into the consolidated kernel CK_{A} while the child kernel DK_{B} has not been merged into the consolidated kernel CK_{A} (i.e. the child kernel DK_{B} may be regarded as a newly invoked child kernel to be merged), the task distributor 620 may link the next pointer NEXT of the metadata MD_{A} to the metadata MD_{B} the child kernel DK_{B} in order to link the child kernel DK_{B} to the child kernel DK_{A}. In other words, when the child kernels DK_{A} and DK_{B} are linked together, the next pointer NEXT of the metadata MD_{A} may point to metadata that is chained/linked after the child kernel DK_{A} in the consolidated kernel CK_{A} (i.e. the metadata MD_{B}). It should be noted that, before the child kernel DK_{B} is linked to the child kernel DK_{A}, the KCE 624 may use the tail pointer PT to store the metadata MD_{A}Of the child kernel DK_{A} (the last metadata linked in the currently generated consolidated kernel CK_{A}), and use the temporary pointer PM to store the metadata MD_{B} of the child kernel DK_{B}. After the child kernel DK_{B} is linked to the child kernel DK_{A}, the KCE 624 may modify the temporary pointer PM by referring to a total number of threads enqueued prior to the child kernel DK_{B} to offset a position of the data pointer base_e of the metadata MD_{B} of the child kernel DK_{B}, wherein the data pointer base_e is used for accessing data of the kernel function to the child kernel DK_{B}. Next, the KCE 624 may replace the tail pointer PT with the modified temporary pointer PM, thereby linking the metadata MD_{A} and the metadata MD_{B} together. The block scheduler (e.g. the block scheduler 330 shown in FIG. 3) may traverse the built linked list for dispatching thread blocks.

It should be noted that, when the child kernel DK_{B} is linked to the child kernel DK_{A}, the KCE 624 may issue an address subtraction instruction (e.g. an atomicSub instruction defined in CUDA) to the DRAM 706 according to the relative positions of the data pointers in the kernel parameters stored in a child information buffer (CIB), wherein each entry of the CIB may record the number of data arrays accessed in a kernel function and the corresponding positions.

In some embodiments, when the consolidated kernel CK_{A} has a sufficient number of threads (e.g. the value stored in the thread number register TR), the KCE 624 may mark the consolidated kernel CK_{A} as available for dispatching by setting up an entry of the TDQ which points to the first metadata of the consolidated kernel CK_{A} (indicated by the head pointer PH), and split the remainder threads of the last metadata (indicated by the tail pointer PT) to generate a new kernel, wherein the KCE 624 may duplicate the kernel parameter of the last metadata, manipulate the data pointer of the new kernel according to the number of threads merged into the consolidated kernel CK_{A} to thereby generate another metadata, and use the another metadata as the first metadata of a next consolidated kernel.

By way of example but not limitation, in a case where a first portion of threads of the child kernel DK_{B} is merged into the consolidated kernel CK_{A}, and a second portion of the threads of the child kernel DK_{B} is not merged into the consolidated kernel CK_{A} (i.e. the consolidated kernel CK_{A} has a sufficient number of threads), the KCE 624 may split the child kernel DK_{B} to generate another child kernel having the second portion of the threads of the child kernel DK_{B}, wherein the metadata of the child kernel DK_{B} includes a first data pointer for data access, and metadata of said another child kernel includes another data pointer for data access. In this example, the KCE 624 may refer to a number of threads in the first portion to manipulate the data pointer to determine the said another data pointer, wherein a distance between a position of the data pointer and a position of said another data pointer is determined according to the number of threads in the first portion

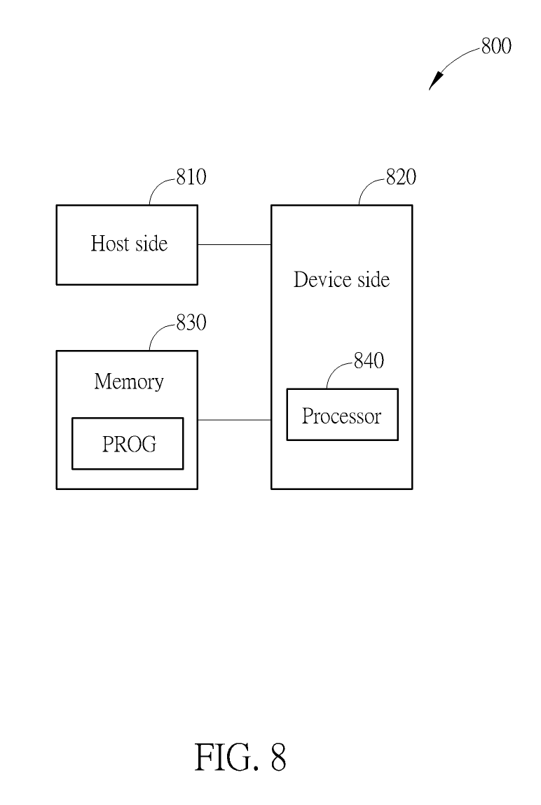

Please note that the aforementioned methods may be implemented in various manners. For example, each step may be translated into a program code by commands, parameters, and variables of a specific program language. Please refer to FIG. 8, which is a block diagram illustrating an exemplary computer system 800 according to an embodiment of the present invention. As shown in FIG. 8, a program code PROG is stored in a non-transitory computer readable medium (e.g. a non-volatile memory) 830, and at least one processor (e.g. a micro control unit or a central processing unit) 840 is instructed to execute each step of the proposed method by fetching and executing the program code PROG. In brief, when executed by the processor 840, the program code PROG causes the processor 840 to execute at least the following steps: linking a plurality of child kernels invoked on a device side 820 to enqueue a plurality of threads of the child kernels, wherein the child kernels are invoked in response to a parent kernel launched from a host side 810; regrouping the threads of the child kernels to generate a plurality of thread blocks each having N threads, wherein N is a positive integer greater than one; merging the thread blocks to generate a consolidated kernel; and executing the consolidated kernel on the device side to execute a kernel function of the child kernels.

To sum up, the proposed dynamic kernel consolidation mechanism may record relative positions of data pointers in kernel parameters, and refer to a selected/determined block size and grid size to dynamically merge multiple child kernels invoked by a device side into at least one consolidated kernel, thereby greatly increasing a processor occupancy (e.g. a streaming multiprocessor occupancy) of the device side.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for executing a plurality of child kernels invoked on a device side, the child kernels being invoked in response to a parent kernel launched from a host side, the method comprising:
linking the child kernels to enqueue a plurality of threads of the child kernels;
regrouping the threads of the child kernels to generate a plurality of thread blocks each having N threads, wherein N is a positive integer greater than one;
merging the thread blocks to generate a consolidated kernel; and
executing the consolidated kernel on the device side to execute a kernel function of the child kernels.

2. The method of claim 1, wherein the child kernels comprise a first child kernel and a second child kernel, and one of the thread blocks comprises at least one thread of the first child kernel and at least one thread of the second child kernel.

3. The method of claim 1, wherein one of the child kernels comprise a first thread block and a second thread block, and one of the thread blocks comprises at least one thread of the first thread block and at least one thread of the second thread block.

4. The method of claim 1, wherein the child kernels comprise a first child kernel and a second child kernel; metadata of the first child kernel comprises a next pointer to metadata which is to be linked to the metadata of the first child kernel; and the step of linking the child kernels to enqueue the threads of the child kernels comprises:
linking the next pointer to metadata of the second child kernel in order to link the second child kernel to the first child kernel.

5. The method of claim 4, wherein the step of linking the child kernels to enqueue the threads of the child kernels comprises:
before the second child kernel is linked to the first child kernel, utilizing a tail pointer to store the metadata of the first child kernel, and utilizing a temporary pointer to store metadata of the second child kernel, wherein the tail pointer points to last metadata linked in the currently generated consolidated kernel;
after the second child kernel is linked to the first child kernel, modifying the temporary pointer by referring to a total number of threads enqueued prior to the second child kernel to offset a position of a data pointer of the metadata of the second child kernel, wherein the data pointer is used for accessing data of the kernel function to the second child kernel; and
replacing the tail pointer with the modified temporary pointer.

6. The method of claim 1, wherein the step of regrouping the threads of the child kernels to generate the thread blocks each having N threads comprises:
calculating a plurality of processor occupancies of a processor on the device side respectively corresponding to a plurality of candidate block sizes, wherein each processor occupancy is a ratio of a number of active warps on the processor to a maximum number of concurrent warps supported by the processor, and each candidate block size is an integer multiple of a number of threads per warp; and
selecting a candidate block size corresponding to a maximum of the processor occupancies as a block size of each of the thread blocks, wherein the candidate block size is N threads per thread block.

7. The method of claim 1, wherein the device side comprises P processors, and Q thread blocks are assigned to each processor; each of P and Q is a positive integer greater than one; and the step of merging the thread blocks to generate the consolidated kernel comprises:
dividing a product of P and Q by a maximum number of concurrent kernels supported by the device side to determine a predetermined number of thread blocks; and
referring to at least the predetermined number of thread blocks to merge the thread blocks to generate the consolidated kernel.

8. The method of claim 7, wherein the step of referring to at least the predetermined number of thread blocks to merge the thread blocks to generate the consolidated kernel comprises
checking if a number of threads in the thread blocks reaches the predetermined number of thread blocks multiplied by N;
wherein when the number of threads in the thread blocks reaches the predetermined number of thread blocks multiplied by N, the generated the consolidated kernel is dispatched for execution.

9. The method of claim 1, wherein a first portion of threads of a first child kernel within the child kernels is merged into the consolidated kernel, and a second portion of the threads of the first child kernel is not merged into the consolidated kernel; and the method further comprises:
splitting the first child kernel to generate a second child kernel having the second portion of the threads of the first child kernel, wherein metadata of the first child kernel comprises a first data pointer for data access, and metadata of the second child kernel comprises a second data pointer for data access; and
referring to a number of threads in the first portion to manipulate the first data pointer to determine the second data pointer, wherein a distance between a position of the first data pointer and a position of the second data pointer is determined according to the number of threads in the first portion.

10. The method of claim 1, wherein the step of executing the consolidated kernel on the device side to execute the kernel function of the child kernels comprises:
when a thread of a child kernel within the plurality of the child kernels is executed, offsetting a position of a data pointer corresponding to the child kernel according to a total number of threads enqueued prior to the child kernel; and
referring to the offset data pointer to access data of the kernel function of the child kernel.

11. The method of claim 1, wherein the consolidated kernel comprises M threads, and M is a positive integer greater than one; and the method further comprises:
storing kernel parameters corresponding to the M threads of the consolidated kernel into M storage elements respectively, wherein each kernel parameter comprises a data pointer for data access.

12. A non-transitory computer readable medium having a program code stored therein, wherein when executed by at least one processor, the program code causes the processor to execute the following steps:
linking a plurality of child kernels invoked on a device side to enqueue a plurality of threads of the child kernels, wherein the child kernels are invoked in response to a parent kernel launched from a host side;
regrouping the threads of the child kernels to generate a plurality of thread blocks each having N threads, wherein N is a positive integer greater than one;
merging the thread blocks to generate a consolidated kernel; and
executing the consolidated kernel on the device side to execute a kernel function of the child kernels.

13. The non-transitory computer readable medium of claim 12, wherein the child kernels comprise a first child kernel and a second child kernel, and one of the thread blocks comprises at least one thread of the first child kernel and at least one thread of the second child kernel.

14. The non-transitory computer readable medium of claim 12, wherein one of the child kernels comprise a first thread block and a second thread block, and one of the thread blocks comprises at least one thread of the first thread block and at least one thread of the second thread block.

15. The non-transitory computer readable medium of claim 12, wherein the child kernels comprise a first child kernel and a second child kernel; metadata of the first child kernel comprises a next pointer to metadata which is to be linked to the metadata of the first child kernel; and the step of linking the child kernels to enqueue the threads of the child kernels comprises:
linking the next pointer to metadata of the second child kernel in order to link the second child kernel to the first child kernel.

16. The non-transitory computer readable medium of claim 15, wherein the step of linking the child kernels to enqueue the threads of the child kernels comprises:
before the second child kernel is linked to the first child kernel, utilizing a tail pointer to store the metadata of the first child kernel, and utilizing a temporary pointer to store metadata of the second child kernel, wherein the tail pointer points to last metadata linked in the currently generated consolidated kernel;
after the second child kernel is linked to the first child kernel, modifying the temporary pointer by referring to a total number of threads enqueued prior to the second child kernel to offset a position of a data pointer of the metadata of the second child kernel, wherein the data pointer is used for accessing data of the kernel function to the second child kernel; and
replacing the tail pointer with the modified temporary pointer.

17. The non-transitory computer readable medium of claim 12, wherein the step of regrouping the threads of the child kernels to generate the thread blocks each having N threads comprises:
calculating a plurality of processor occupancies of a processor on the device side respectively corresponding to a plurality of candidate block sizes, wherein each processor occupancy is a ratio of a number of active warps on the processor to a maximum number of concurrent warps supported by the processor, and each candidate block size is an integer multiple of a number of threads per warp; and
selecting a candidate block size corresponding to a maximum of the processor occupancies as a block size of each of the thread blocks, wherein the candidate block size is N threads per thread block.

18. The non-transitory computer readable medium of claim 12, wherein the device side comprises P processors, and Q thread blocks are assigned to each processor; each of P and Q is a positive integer greater than one; and the step of merging the thread blocks to generate the consolidated kernel comprises:
dividing a product of P and Q by a maximum number of concurrent kernels supported by the device side to determine a predetermined number of thread blocks; and
referring to at least the predetermined number of thread blocks to merge the thread blocks to generate the consolidated kernel.

19. The non-transitory computer readable medium of claim 18, wherein the step of referring to at least the predetermined number of thread blocks to merge the thread blocks to generate the consolidated kernel comprises
checking if a number of threads in the thread blocks reaches the predetermined number of thread blocks multiplied by N;
wherein when the number of threads in the thread blocks reaches the predetermined number of thread blocks multiplied by N, the generated the consolidated kernel is dispatched for execution.

20. The non-transitory computer readable medium of claim 12, wherein a first portion of threads of a first child kernel within the child kernels is merged into the consolidated kernel, and a second portion of the threads of the first child kernel is not merged into the consolidated kernel; and the method further comprises:
splitting the first child kernel to generate a second child kernel having the second portion of the threads of the first child kernel, wherein metadata of the first child kernel comprises a first data pointer for data access, and metadata of the second child kernel comprises a second data pointer for data access; and
referring to a number of threads in the first portion to manipulate the first data pointer to determine the second data pointer, wherein a distance between a position of the first data pointer and a position of the second data pointer is determined according to the number of threads in the first portion.

21. The non-transitory computer readable medium of claim 12, wherein the step of executing the consolidated kernel on the device side to execute the kernel function of the child kernels comprises:
when a thread of a child kernel within the plurality of the child kernels is executed, offsetting a position of a data pointer corresponding to the child kernel according to a total number of threads enqueued prior to the child kernel; and
referring to the offset data pointer to access data of the kernel function of the child kernel.

22. The non-transitory computer readable medium of claim 12, wherein the consolidated kernel comprises M threads, and M is a positive integer greater than one; and the method further comprises:
storing kernel parameters corresponding to the M threads of the consolidated kernel into M storage elements respectively, wherein each kernel parameter comprises a data pointer for data access.
